(19) United States
(12) Patent Application Publication
(10) Pub. No.: US 2010/0085940 A1
(43) Pub. Date: Apr. 8, 2010

(54) HANDOFF PROCEDURES AND INTRA-NETWORK DATA ROUTING FOR FEMTOCELL NETWORKS

(76) Inventor: James Michael Murphy, Alameda, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/570,958

(22) Filed: Sep. 30, 2009

Related U.S. Application Data
(60) Provisional application No. 61/101,627, filed on Sep. 30, 2008.

(51) Int. Cl. H04W 36/06; H04W 36/12

(52) U.S. Cl. 370/331; 370/411

(57) ABSTRACT

The present invention is directed toward a system and method for enabling handoffs of a connected mobile device between an external macrocell access point and a local femtocell access point without interrupting data communication sessions occurring on that connected mobile device. In some embodiments, this entails maintaining an IP address assigned to the connected mobile device during and after the handoff procedure. In further embodiments, this process is enabled by providing a virtual private network link between the external support node and a local access point controller.

### CROSS-REFERENCE TO RELATED APPLICATIONS

This application claims the benefit of U.S. Provisional Application No. 61/101,627, filed Sep. 30, 2008, which is hereby incorporated by reference in its entirety.

### TECHNICAL FIELD

The present invention relates generally to communication networks, and more particularly, some embodiments relate to interactions between femtocell networks and external cellular networks.

### DESCRIPTION OF THE RELATED ART

Femtocells or access point base stations are small cellular base stations typically used in buildings, residential environments, or locations with limited lines of sight to nearby antennae. Femtocells enable multiple mobile phones within range to connect to a cellular network through a broadband connection. Femtocells typically use a combined software and signal processing unit and radio frequency (RF) sub-system to decode and encode, or demodulate and modulate wireless signals into useful information, e.g. Internet web pages that can be transmitted on an IP or Ethernet interface. These low-cost units are typically designed for residential deployments and typically operate as if they were small macrocell access points. Accordingly, typical multi-cell femtocell systems are established in similar manners to multi-cell macrocell systems. Current multi-cell femtocell systems that can be configured to allow connected mobile devices to establish data sessions with a local intranet, for example by providing the connected mobile device with a local IP address, are not equipped to maintain these sessions during handoff procedures between the femtocell network and a surrounding macrocell network.

### BRIEF SUMMARY OF EMBODIMENTS OF THE INVENTION

The present invention is directed toward a system and method for enabling handoffs of a connected mobile device between an external macrocell access point and a local femtocell access point without interrupting data communication sessions occurring on that connected mobile device. In some embodiments, this entails maintaining an IP address assigned to the connected mobile device during and after the handoff procedure. In further embodiments, this process is enabled by providing a virtual private network link between the external support node and a local access point controller.

According to an embodiment of the invention, a communications system, comprises a local femtocell access point base station; a local access point controller in communication with the local femtocell access point base station and an external network support node, wherein the external network support node is in communication with an external macrocell access point base station; a local DHCP server; wherein the external network support node is configured to assign an IP address using the local DHCP server to a first affiliated mobile device if the mobile device connects to the system using the external macrocell access point base station and if the device connects to the system using the local femtocell access point base station; wherein the external network support node is configured to direct IP data traffic from the affiliated mobile device to the local access point controller if the affiliated mobile device is connected to the external macrocell access point base station; and wherein the local access point controller is configured to enable an inbound handoff of the affiliated mobile device from the external macrocell access point base station to the local femtocell access point base station and is configured to enable an outbound handoff of the affiliated mobile device from the local femtocell access point base station to the external macrocell access point base station, wherein the IP address is maintained after the inbound handoff and after the outbound handoff.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating a simplified architecture for an example environment in which embodiments of the invention may be implemented.

FIG. 2 illustrates a basic structure of an exemplary network architecture according to an embodiment of the invention.

FIG. 3 illustrates an example network according to an embodiment of the invention.

FIG. 4 illustrates the example network of FIG. 3 after a handoff procedure has taken place.

FIG. 5 illustrates an embodiment of the invention in an environment having a plurality of access controllers.

FIG. 6 illustrates another embodiment of the invention in an environment having a plurality of access controllers.

FIG. 7 illustrates an exemplary access point that may be used in some embodiments of the invention.

FIG. 9 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

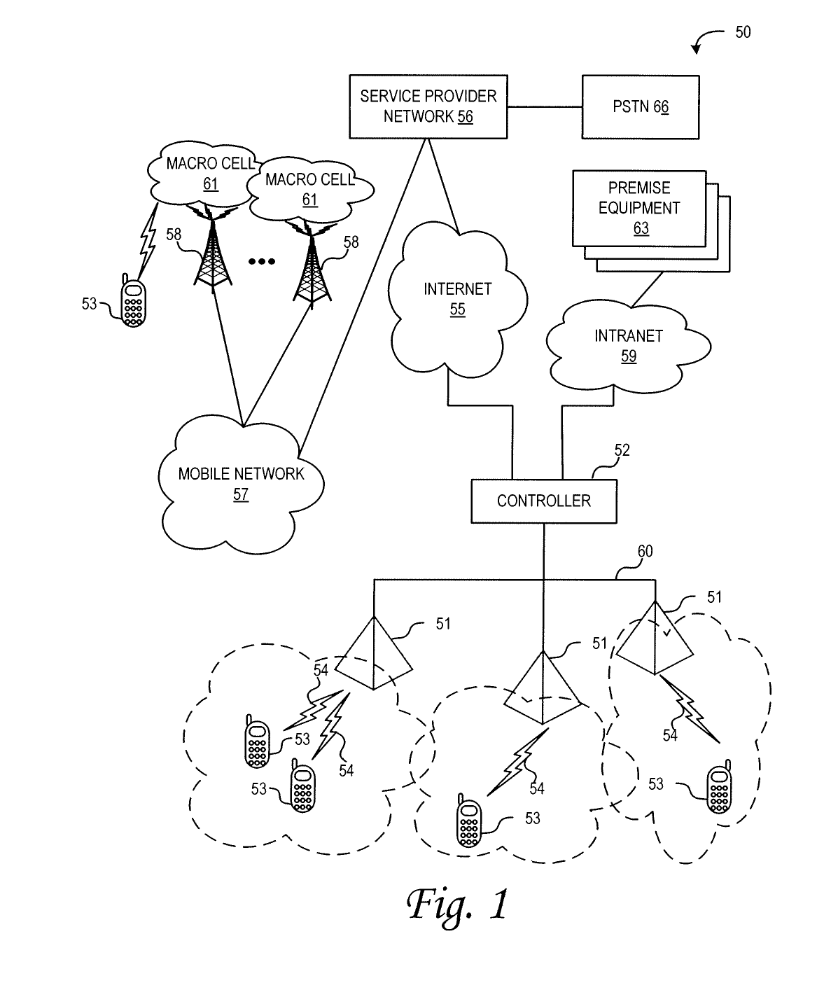

Before describing the invention in detail, it is useful to describe an example environment in which the invention can be implemented. One such example is that of a centrally-controlled femtocell system. FIG. 1 is a diagram illustrating a simplified architecture for such an example environment. In this example environment, one or more femtocells provide cellular coverage for wireless terminals (handsets or other user equipment, for example). In the illustrated example, femtocells 51 serve as base stations to provide cellular coverage over an air interface 54 to user equipment 53 within their respective areas of coverage. For example, femtocells 51 may be deployed at various locations within a building or other structure to provide cellular coverage to user equipment 53 within the building or structure. This can be advantageous, for example, in large buildings, underground facilities, within aircraft or other transportation vehicles, and within other structures and locations where conventional macro cell coverage is weak or insufficient. Consider the case of a building with a plurality of femtocells distributed therein. In such an environment, the user equipment 53 registers with a femtocell 51 in its range within the building. As the user moves throughout the building, her cellular handset (or other terminal) may be handed off from one femtocell 51 to another to provide suitable coverage for her user equipment 53 as she moves within the building. In some embodiments, the coverage provided by femtocells 51 may be apportioned into multiple networks (“access point networks”). For example, multiple access point networks (APNs) may be provided for different mobile devices to interact with their respective service provider networks, or multiple networks may be provided to give different users different amounts of access to an enterprise network. In such embodiments, the controller 52 may therefore have control over multiple APNs and may be responsible for controlling multiple mobile devices' access to these APNs.

In various embodiments, user equipment 53 may comprise, for example, a cellular or mobile handset, a PDA having cellular system access, a laptop with cellular system access for data transmission over cellular systems, or other devices capable of accessing licensed spectrum communications networks for voice or data transmissions. In such applications, femtocells 51 are wireless access points configured to operate within the licensed spectrum to serve as base stations for the user equipment within their range. In other embodiments, femtocells 51 can be implemented as wireless access points for communications with compatible wireless terminals over proprietary or other non-licensed air interface. Although femtocells 51 are illustrated as exclusively wireless access points, embodiments can be implemented wherein femtocells 51 are implemented with wired interfaces to user equipment or a combination of wired and wireless interfaces.

As noted above, femtocell 51 operates as a base station and relays voice and data communication between the user equipment 53 and an end destination. For example, the end destination can be other user equipment within the building (for example, other wireless terminals 53, or other premise equipment 63), a cellular handset operating on a macro cell 61, the PSTN 66, Internet 55 accessible devices and so on.

In the illustrated environment, the femtocells 51 are centrally controlled by a controller 52, sometimes referred to as an access controller. Controller 52 may perform various functions, such as, for example, monitoring operations, coordinating communications among user equipment 53, relaying communications between user equipment 53 and other entities, licensed spectrum allocation, or load balancing amongst the femtocells 51. Femtocells 51 can be connected to access controller 52 via a backhaul 60 which can be implemented using a number of different communication topologies.

Femtocells 51 are configured to provide cellular system access by transmitting voice and data transmissions to controller 52, which routes the communications via a packet switched network, such as the Internet 55, via an Intranet 59 or other communication path as appropriate. Accordingly, in some environments controller 52 may comprise a router or switch configured to allow the femtocells 51 to share a network connection and to access networks 55, 59. Controller 52 may also be configured to make routing determinations from among the various entities such that communications with a given wireless terminal 53 may be routed to at least one of the mobile network 57, other femtocells 51 other premise equipment 63 attached to the intranet 59, or other entities as may be accessible by controller 52.

In some examples, the system may further comprise a local intranet 59. For example, the controller 52 and femtocells 51 may be maintained by or integrated with an entity, such as a business or organization that also maintains its own local intranet 59. In some cases, users of the user equipment 53 may desire access to the intranet 59, such as for local data transfers or local voice calls. In such environments, the controller 52 may also mediate these communication activities.

The example environment further comprises a service provider network system 56. For example, the service provider network system may comprise a 2G or 2.5G network such as GSM, IS-95, PDC, iDEN, IS-136, 3G based network such as GSM EDGE, UMTS, CDMA2000, DECT, or WiMAX, or any other cellular or telecommunications or other network. Service provider network system 56 further comprises a cellular network 57, that can include mobile switching centers, base station controller and base stations 58 configured to provide macro cell coverage 61 in the environment.

Sometimes, the coverage area of macrocell 61 may overlap with that of femtocells 51, in such cases the controller 52 or the femtocells 51 may provide methods for mitigating interference between the elements. In some instances, user equipment 53 may move from areas covered by femtocells 51 to areas covered by macrocell 61. In these cases, the controller 52 may provide methods for handing off calls from the femtocells 51 to the macrocell 61. In other cases, other network elements may mediate these transitions.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

For example, the innovations described herein often refer to access points and access controllers. As would be apparent to one of ordinary skill in the art after reading this description depending on the nature of the innovation, various embodiments may implement these components as components of a femtocell network (such as the example described with reference to FIG. 1, or as other access point and controller elements (e.g., base stations and base station controllers) in macro cells or other like topologies.

The present invention is directed toward a system and method for enabling handoffs of a connected mobile device between an external macrocell access point and a local femtocell access point without interrupting data communication sessions occurring on that connected mobile device. In some embodiments, this entails maintaining an IP address assigned to the connected mobile device during and after the handoff procedure. In further embodiments, this process is enabled by providing a virtual private network link between the external support node and a local access point controller. In still further embodiments, the local access point controller and the local femtocell access point are in communication with a local intranet. In these embodiments, the local access point controller is configured to provide local switching or routing to the local intranet for mobile devices that are connected to the local femtocell access point and to mobile devices that are connected to the external macrocell access point. In some embodiments, this process is enabled by configuring the external support node to direct IP traffic from a mobile device connected to the external macrocell access point to the local femtocell access point controller.

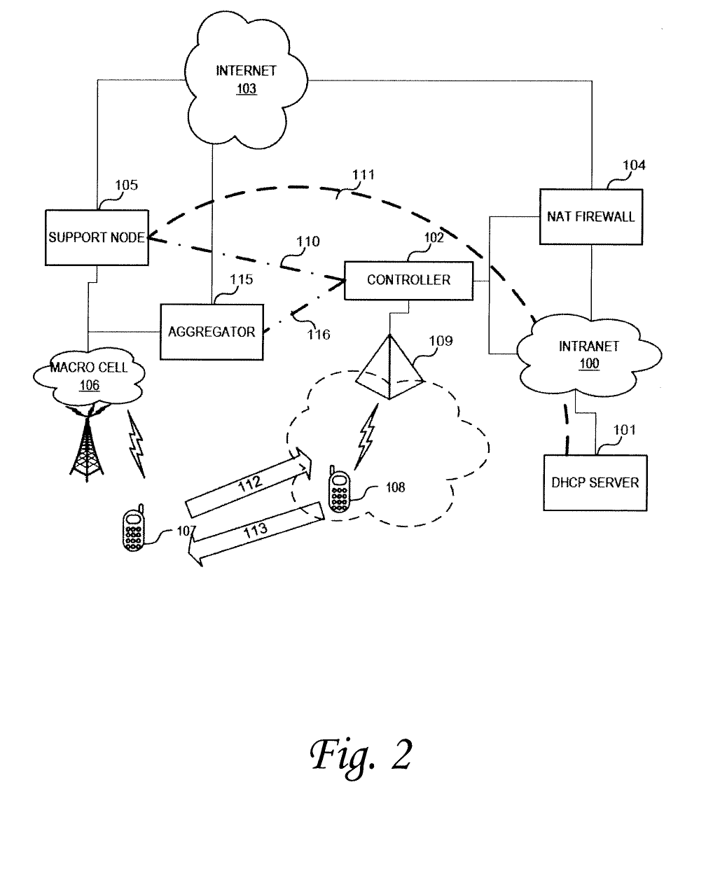

FIG. 2 illustrates a basic structure of an exemplary network architecture according to an embodiment of the invention. In this embodiment, an external portion of a cellular network includes support node 105. For example, external support node 105 may comprise a gateway GPRS support node (GGSN) of a cellular network implementing a general packet radio service (GPRS) system, such as a GSM system. In the cellular network, a particular entity may operate a sub-portion of the network to provide extra or enhanced coverage to a particular area, or a particular group of users. In this embodiment, such a local or enterprise portion of the cellular network includes femtocell access point 109 and access point controller 102. For example, controller 102 and femtocell 109 may comprise elements within a femtocell cellular sub-network as described with respect to FIG. 1, where controller 102 is configured to manage the connectivity of a particular set of users or to manage the configuration of the femtocell 109. One or more femtocells 109 may be configured to provide voice and data communication capabilities to affiliated mobile devices 108. For example, an enterprise may establish a list of registered mobile devices 108 that are authorized to access the coverage area provided by femtocells 109. In this embodiment, the enterprise sub-network also includes a local intranet 100. Various affiliated mobile devices 108 may also be granted access to the local intranet 100. For example, a list of user identities associated with registered authorized intranet users may be maintained. In some embodiments, this controller 102 may be further configured to route data traffic between the authorized users, such as the locally affiliated mobile device 108, and the intranet 100.

In further embodiments, the controller may be connected to an external network, such as the Internet 103, for example via a NAT client or firewall 104. In addition to providing locally affiliated network device 108 with access to the local intranet 100, the controller may also be configured to provide the mobile device 108 with access to this external network. For example, the controller may be configured to route traffic between mobile device 108 and intranet 100 or Internet 103 according to the traffic destination. In further embodiments, the controller 102 may be equipped with a policy that allows the controller to determine which affiliated devices get direct access to the local intranet 100. For example, this policy may be based on the mobile devices the user identity or the network to which the mobile device requests connection. In further embodiments, because the support node 105 has authenticated and authorized a particular mobile device for that network through communications with the service provider, the AC can use this authorization to allow the mobile device direct access to the local network. Accordingly, in one embodiment, the controller 102 or another network element maintains a list of affiliated mobile devices that are authorized to access the local intranet 100. When affiliated mobile devices connect to either the macrocell 106 or the femtocell 109, the controller is able to locally switch traffic directed to the local intranet 100 without routing traffic through the external cellular network elements, such as the external support node 105. In this embodiment, if non-affiliated mobile devices are allowed to connect to the femtocell network 109, the controller can route all such traffic directly to an external network aggregator 115, such as a home node B gateway, over a second connection 116, such as a GPRS tunneling protocol (GTP) connection, thereby allowing the non-affiliated mobile devices to use the local network's femtocell coverage areas without providing them access to other local network elements.

In the illustrated embodiment, the system is further configured to provide externally connected mobile devices 107 with access to the local intranet 100. For example, a mobile device 107 may be the mobile device of an authorized user desiring access to the intranet 100 from a location within the coverage area of macrocell 106. Accordingly, to securely provide such a connection, a virtual private network connection (VPN) 110 is established between the local network and the external network. In some embodiments, this VPN 110 is formed between external network support node 105 and the controller 102. Accordingly, the support node 105 may be configured to route IP traffic from mobile device 107 to the controller 102 via the VPN 110. The support node 105 may be provided with a table of affiliated devices, such as mobile devices 107 and 108, and may be configured to route all data traffic it receives from these mobile devices to controller 102. Accordingly, as with a locally connected devices 108, the controller 102 may be configured to route traffic from externally connected to affiliated device 107 to the local intranet 100, or to the external network 103. Furthermore, because controller 102 is also in communication with local femtocells 109, the controller 102 may also mediate direct data connections between externally connected device 107 and internally connected device 108.

In the illustrated embodiment, the enterprise intranet 100 also comprises a dynamic host control protocol (DHCP) server 101. The DHCP server 101 is configured to provide IP addresses to both internal connected device 108 and external connected device 107. In the case of the external connected device 107, the support node 105 may be preconfigured with the ability to provide connected mobile devices with IP addresses. Accordingly, in this embodiment of the invention, support node 105 may be configured to retrieve IP addresses for certain affiliated devices, such as enterprise registered devices, using DHCP server 101. In some embodiments, support node 105 may be able to retrieve these addresses using a connection 111 that is under its control. In other embodiments, the controller may retrieve the address from DHCP server 101 and provide it to the support node 105 via the VPN 110. Because support node 105 is configured to route data traffic for external mobile device 107 directly to controller 102, the IP address assigned to external device 107 may comprise a local network system IP address. Having a local IP address does not interfere with the external mobile device's connection to Internet 103 because this connection is routed through the controller 102 and the network address translation (NAT) firewall 104. In some embodiments, the controller 102 may direct the IP assignment procedure to be handled by support node 105 even when local device 108 is initially connecting to femtocell 109. For example, pre-established cellular network connection protocols may require the support node 105 to provide the IP address regardless of the mobile device's connection location. In other embodiments, because support node 105 is already configured to provide IP addresses to externally connected devices 107, duplicating this function can be avoided by allowing the support node 105 to provide IP addresses to locally connected devices 108. This also allows the data connection setup procedures between the mobile device 108 and support node 105 to proceed as they normally would for connections from the macrocell 106.

When the external mobile device 107 enters 112 the local femtocell's 109 coverage area, a handoff procedure may maintain the local IP address assigned to device 107, thereby maintaining then-occurring data traffic sessions. Because controller 102 is in communication with femtocell 109, controller 102 can be made aware that an external affiliated mobile device 107 is connecting 112 to the local femtocell 109. Accordingly, it can update its routing tables with the new location of mobile device 107 such that existing IP sessions may be continued without interruption. Furthermore, in embodiments where a plurality of femtocells 109 are present and connected to controller 102, the controller 102 is aware of handoffs amongst this plurality, and is thereby able to maintain an updated routing table so that data sessions are not interrupted during movement within the local femtocell network.

Similarly, because external support node 105 is configured to direct traffic from affiliated devices to and from controller 102 via the VPN 110, external support node 105 and controller 102 are able to conduct handoffs for devices leaving 113 the local femtocell network. When internally connected mobile device 108 leaves 113 the coverage area, the support node 105 is aware of its attempts to connect to macrocell 106. Accordingly, it may implement a handoff procedure where it updates its routing tables so that future data traffic from mobile device 108 is routed to the controller 102. The controller 102 is also able to update its routing table so that future traffic destined for mobile device 108 is routed to the support node 105 via VPN 110.

In some further embodiments, the femtocell 109 and the controller 102 may be co-located in one network device. For example, the femtocell 109 and the controller 102 may comprise control modules contained within a common housing. Such a network device having both controller and femtocell modules might be employed in residential areas where a particular residence would not need more than one femtocell access point force cellular coverage but would still desire to provide access to an intranet 100. In this embodiment, a network device comprising a femtocell 109 having a VPN connection 110 to a external support node 105 could allow registered users to have access to their home networks anywhere within the macro network coverage area. Because VPN 110 may be implemented with various security features, this connectivity may be provided in a sufficiently secure manner. As described herein, and externally connecting affiliated mobile device could be given a local IP address in a home network 100 including, for example, security systems, security cameras, home entertainment systems, appliances, personal computers, so that the user could communicate with and control elements within this network.

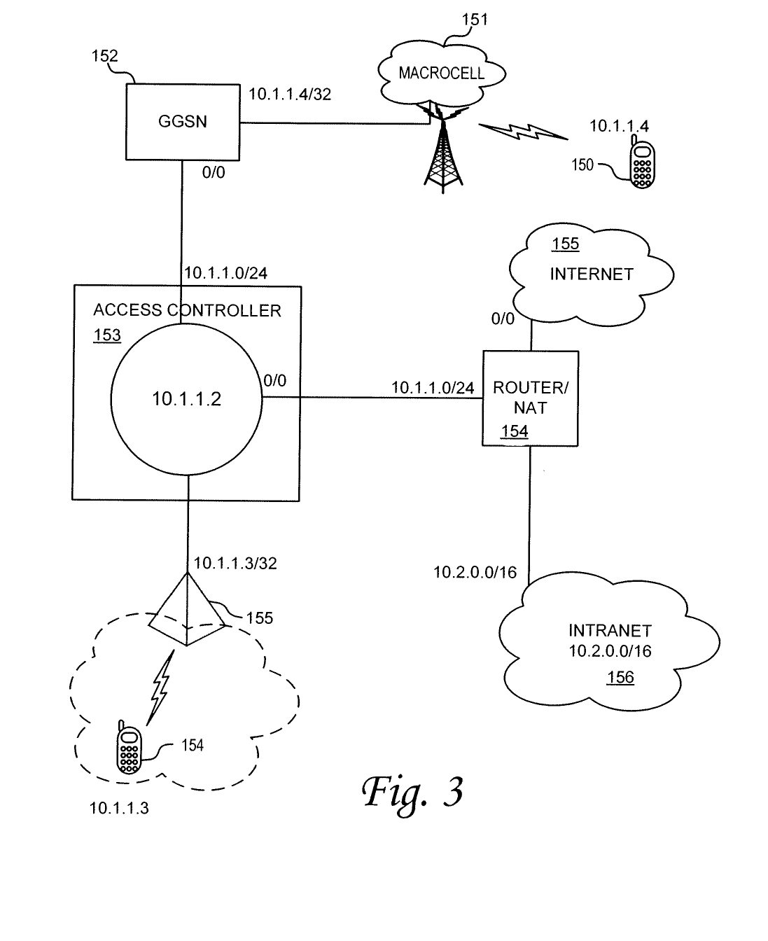

FIG. 3 illustrates an example network according to an embodiment of the invention. In this embodiment, for ease of explanation, the external cellular network is assumed to be a GSM type network wherein the support node is a GGSN 152, although other network elements and network types may be employed. For ease of explanation, example local Internet addresses and routes have been assigned as illustrated. In this embodiment, externally connected mobile device 150 is assigned the address 10.1.1.4, locally connected mobile device 154 is assigned the address 10.1.1.3, access controller 153 is assigned the IP address 10.1.1.2, and the routes to the various network devices are implemented according to the address numbers illustrated that the various interfaces to the various elements. In the illustrated embodiment, the GGSN 152, access controller 153, and router/NAT 154 all have routing capabilities. The following tables summarize the routing tables for the various elements in the illustrated example:

Router/NAT 154:

| Route | Interface (type) |
|---|---|
| 10.1.1.0/24 | To Access Controller 153 |
| 0/0 | To Internet 155 (via NAT 154) |
| 10.2.0.0/16 | To Intranet 156 |

Access Controller 153::

| Route | Interface |
|---|---|
| 10.1.1.0/24 | To GGSN 152 |
| 0/0 | To Router/NAT 154 |
| 10.1.1.3/32 | To Femtocell Access Point 155 |

GGSN 152

| Route | Interface (type) |
|---|---|
| 0/0 | To Access Controller 143 |
| 10.1.1.4/32 | To Macrocell 151 |

In the illustrated embodiment, a traffic flow for a mobile device 154 connected to local femtocell 155 accessing a local network service in the intranet 156 is as follows. For sake of explanation, the local network service will be assumed to have an IP address of 10.2.2.2. Although this element is not shown in the figure, is assumed to be located in intranet 156. In the direction from the mobile device 154 to the network service, this traffic flow occurs between 10.1.1.3 (the mobile device 154) and 10.2.2.2 (the network service). A packet from mobile device 154 has destination address 10.2.2.2. This packet is forwarded to the access controller 153 by the femtocell access point base station 155. At the access controller 153, the 0/0 (default) route is matched and the packet is sent to the router/NAT 154. At the router/NAT 154, 10.2.0.0/16 is matched and the packet is forwarded to the Intranet 156, and the network service at 10.2.2.2, specifically. In the opposite direction, a packet from the network service at 10.2.2.2 to the mobile device 154 has a destination address of 10.1.1.3. It arrives on the router/NAT 154 by virtue of existing intranet routing protocols. At the router/NAT 154 it matches the 10.1.1.0/24 route and is forwarded to the access controller 153. At access controller 153, it matches the 10.1.1.3/32 route and is forwarded to the femtocell access point 155 where it is transmitted to the mobile device 154 having address 10.1.1.3.

A second exemplary network traffic flow for mobile device 154 accessing an Internet 155 service, such as a search at www.google.com at 74.125.19.104, is as follows. In the mobile device 154 to Internet 155 direction, a packet has a destination address of 74.125.19.104. This packet arrives at the access controller 155 and matches the 0/0 route to the router/NAT 154. At the router/NAT 154, it matches the 0/0 route. In the illustrated example, the 0/0 router would specify a NAT operation and the packet would then forwarded to the Internet 155 with the appropriate NAT state for the flow on the Router/NAT device 154. For example, the source address of the packet may be translated to such as the local network operators public IP address, for example, 216.64.210.28. In the opposite direction, a packet from 74.125.19.104 to 216.64.210.28 arrives on the Router NAT 154, and due to the NAT state established in the flow in the outcome direction, the destination address is translated to 10.1.1.3. The packet is then forwarded via 10.1.1.0/24 to the access controller 153 where it is then forwarded via the 10.1.1.3/32 route to the femtocell access point 155, and to mobile device 154 at 10.1.1.3.

A third exemplary network flow, between an externally connected mobile device 150 and a locally connected mobile device 154, is as follows. In the outbound direction, where mobile device 154 transmits a packet to mobile device 150, the destination address is 10.1.1.4. The packet arrives at the access controller 153 and is forwarded to the GGSN 152 via the 10.1.1.0/24 route. At the GGSN 152, it is forwarded to the macrocell access point 151 via the 10.1.1.4/32 route, and transmitted to the mobile device 150 at 10.1.1.4. In the opposite direction, a packet from externally connected mobile device 150 to the locally connected mobile device 154 has a destination IP address of 10.1.1.3. At the GGSN 152, the packet is forwarded to the access controller 153 via the 0/0 route. At the access controller 153, the packet is forwarded to the femtocell access point 155 via the 10.1.1.3/24 route, and transmitted to the mobile device 154 at 10.1.1.3.

A fourth exemplary network flow, illustrating the case of an externally connected affiliated mobile device 150 accessing a local intranet 156 network service, for example at 10.2.2.2, is as follows. In the inbound direction, a packet from mobile device 150 at 10.1.1.4 has a destination address of 10.2.2.2. This packet arrives at the GGSN 152 and is forwarded to the access controller 153 via the 0/0 route. At the access controller 153, it is forwarded to the router/NAT 154 via the 0/0 route. At the router/NAT 154, the processing is the same as the case described above of the local mobile device 154 accessing the network service. In the opposite direction, a packet from 10.2.2.2 having a destination address of 10.1.1.4 arrives on the router/NAT 154 and is forwarded to the access controller 153 via the 10.1.1.0/24 route. At the access controller 153, it is forwarded to the GGSN 152 via the 10.1.1.0.24 route. At the GGSN 152, it is forwarded to the macrocell access point 151 via the 10.1.1.4/24 route and transmitted to the mobile device 150 at 10.1.1.4. In a similar manner, network traffic between externally connected affiliated mobile device 150 to the Internet 155 may be routed through the access controller 153 and the router/NAT 154.

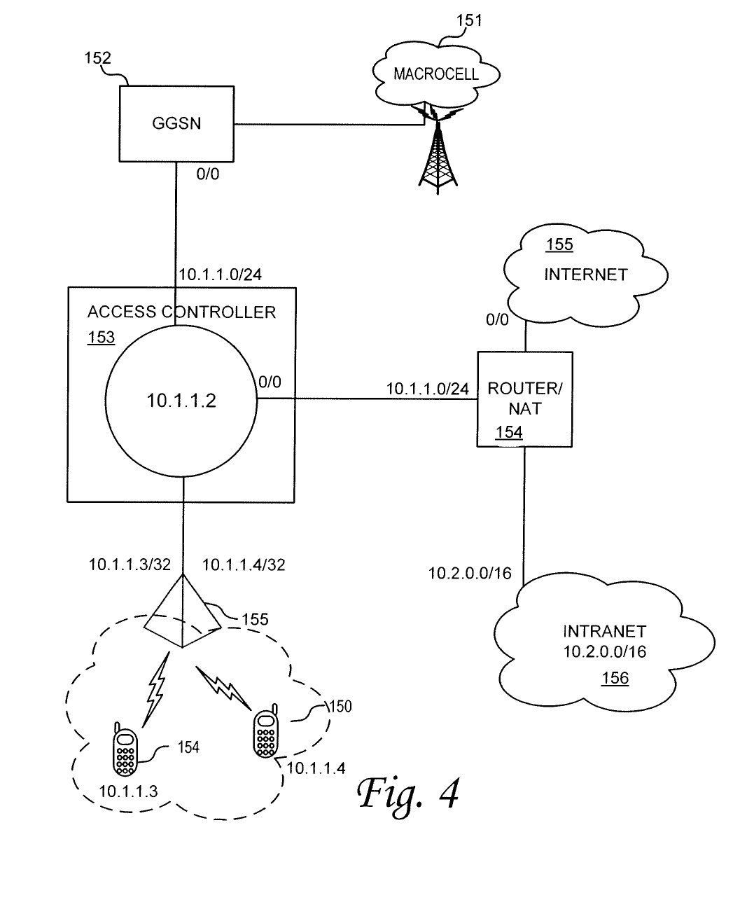

FIG. 4 illustrates the example network of FIG. 3 after a handoff procedure has taken place and mobile device 150 has entered the local femtocell network, in accordance with an embodiment of the invention. During a handoff procedure between macrocell 151 and femtocell 155, the various routing tables of the network elements may be updated to indicate the routing change, without disrupting or changing the IP address of the individual network elements. The following tables illustrate the changes to the routing tables after such a handoff procedure:

Router/NAT 154:

| Route | Interface (type) |
|---|---|
| 10.1.1.0/24 | To Access Controller 153 |
| 0/0 | To Internet 155 (via NAT 154) |
| 10.2.0.0/16 | To Intranet 156 |

Access Controller 153::

| Route | Interface |
|---|---|
| 10.1.1.0/24 | To GGSN 152 |
| 0/0 | To Router/NAT 154 |
| 10.1.1.3/32 | To Femtocell Access Point 155 |
| 10.1.1.4/32 | To Femtocell Access Point 155 |

GGSN 152

| Route | Interface (type) |
|---|---|
| 0/0 | To Access Controller 143 |

After this handoff procedure, the data flows involving the first locally connected mobile device 154 at 10.1.1.3 and the Internet 155 or intranet 156 remain the same. Data flows involving the now locally connected mobile device 155 at 10.1.1.4 and the networks 155 and 156 are substantially similar to those involving mobile device 154. Additionally, data transfers between mobile devices 150 and 154 may now be handled entirely locally because access controller 153 has control over both end points, 10.1.1.3/32 and 10.1.1.4/32.

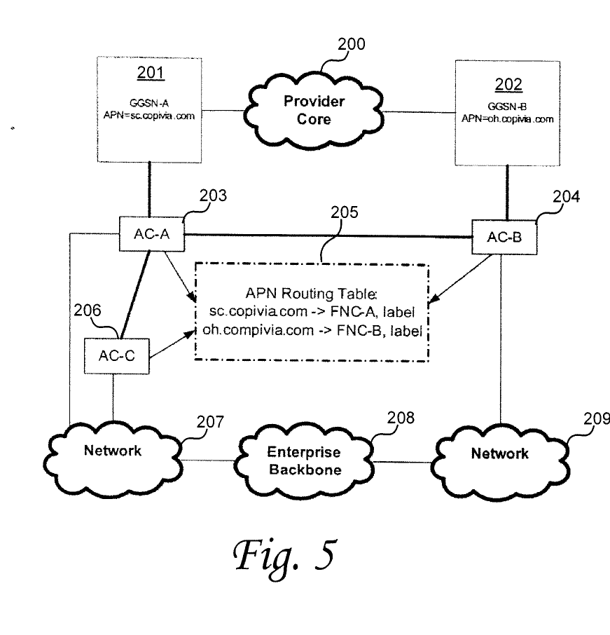

Various embodiments of the invention may employ multiple access controllers. For example, an entity implementing a femtocell network as described herein may desire to install more femtocell access points than a single access controller can manage, or an entity may wish to extend its network across multiple locations and it may be more practical to install a controller at each location to manage that location's femtocell access points. Furthermore, different locations may be provided with separate femtocell access points networks or, in some embodiments, separate femtocell access point networks (APN) may coexist within a single entity's network system. Furthermore, in some embodiments, a single access controller may be able to host multiple APNs, that may be established using the femtocell access points under its control. For example, an entity may establish a first APN for visiting mobile devices and a second APN for affiliated mobile devices, or the entity may establish multiple APNs corresponding to different levels of access granted to various affiliated mobile devices. Accordingly, a variety of methods may be used to implement embodiments of the invention in environments having multiple access controllers and multiple APNs. FIG. 5 illustrates an example of one such embodiment in an environment where the mobile devices are configured to exist in an UMTS network.

In the embodiment illustrated in FIG. 5, an APN routing table 205 is constructed and shared by all the access controllers 203, 204, and 205 that are operated by the entity. In this embodiment, different access controllers may be associated with different femtocell access point networks. For example, in the illustrated embodiment, access controllers 203 and 206 are associated with network 207, while access controller 204 is associated with network 209. Furthermore, mobile devices connecting to the networks may be associated with different controllers. For example, a first mobile device connected to network 207 may associate with access controller 206, while a second mobile device may be associated with access controller 203. This might occur, for example, if network 207 comprise a plurality of femtocell access points and different access points were put under the control of different access controllers. Accordingly, the routing table maps an APN with its associated access controllers, and further maps connected mobile devices to their associated access controllers. For example, if a mobile device configured to access network 209 associates with access controller 203 then access controller 203 may partake in the entire packet data packet (PDP) context establishment as it would normally do with the provider core 200. However, when it comes to data forwarding, access controller 203 may be configured to establish a tunnel with access controller 204 for APN 209 so that it can forward traffic to access controller 204 via that tunnel. Access controller 204 may then route the traffic directly on the network. Similarly, when traffic to the mobile device arrives on access controller 204, access controller 204 has access to the routing table 205 so that a tunnel may be established for the connected mobile device to access controller 203. The traffic may then be tunneled to access controller 203, where it is then forwarded to the mobile device.

In an embodiment where an access controller may host multiple APNs, a label may be specified in the APN routing table to identify to which network the packet should be forwarded. In the illustrated example, the tunnel setup protocol includes the IP address and the label to be used when forwarding packets access controller 204. In this embodiment, access controller 204 uses this label when forwarding packets to access controller 203 so that access controller 203 can find the correct routing instance.

Some entities may not wish to tunnel data between certain access controllers and may prefer to use the provider network 200, for example with support nodes 202 and 201 connected to the access controllers. In some embodiments, these situations may be accommodated via policy that indicates that certain access controller pairs should not be permitted to tunnel.

In further embodiments, APN routing may be more practical when two access controllers are close to each other within the entity network, but only one hosts the APN. This situation is illustrated with respect to access controller 206. If access controller 206 were to handle the connection of any mobile device to APN 207 it could be configured to tunnel data traffic to access controller 203.

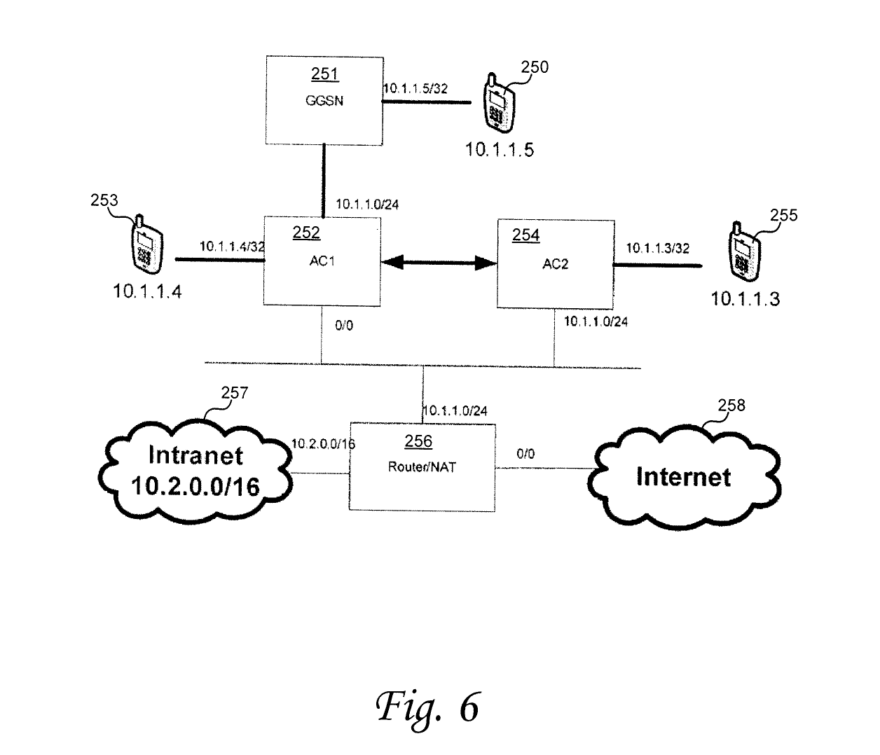

FIG. 6 illustrates another example of an embodiment of the invention implementing multiple access controllers in a UMTS network. In this embodiment, the various network elements are illustrated with IP addresses and IP routes in a similar manner to that of FIGS. 3 and 4. In this embodiment, a connection, such as a tunnel, is established between GGSN 251 and access controller 252. Accordingly, access controller 252 is established as the “owner” of subnet 10.1.1.0/24 and answers address resolution protocol (ARP) requests for addresses on that subnet. When a packet arrives at access controller 252, it is either forwarded to the GGSN 251 via the 10.1.1.0/24 route; forwarded to an associated mobile device, such as mobile device 253 at 10.1.1.4 via the 10.1.1.4/32 route; or to the rest of the subnet via the 0/0 route. In the illustrated embodiment, the multiple access controllers 252 and 254 establish a communications channel. Accordingly, the access controller 254 may learn that access controller 252 is the owner of the subnet. In which case, access controller 254 may inform access controller 252 whenever a mobile device, such as mobile device 255 at 10.1.1.3, associates with access controller 254. In further embodiments, the access controller 254 may also be configured to perform a gratuitous ARP to attract packets from the router/NAT 256 destined for 10.1.1.3.

In the illustrated embodiment, when mobile device 255 at 10.1.1.3 disassociates from access controller 254, access controller 252 is notified. Access controller 252 may then perform a gratuitous ARP to attract packets that are destined for 10.1.1.3 back to access controller 252. Accordingly, whether mobile device 255 at 10.1.1.3 associates with a different access controller, access controller 252, or a macrocell associated with GGSN 251, access controller 252 can update its routing tables so that data sessions occurring on mobile device 255 are not interrupted. In the illustrated embodiment, the access controller 252 may be further configured to handle ARP requests for all addresses on the subnet that are not being handled by access controller 254. This may be done of whether there is a mobile device associated with access controller 252 to account for situations where a mobile device is associated with the GGSN 251. In this example, these packets would match the 10.1.1.0/24 entry in access controller 252's routing table.

In further embodiments, an interior gateway routing protocol, such as ISIS or OSPF, may be run between the access controllers 253 and 255 and router/NAT 256. In these embodiments, rather than relying on ARP to attract packets to the appropriate access controllers in the network, host routes can be advertised by the access controllers to attract packets to attached mobile devices. For example, in the illustrated embodiment access controller 252 would advertise the route 10.1.1.0/24 that it has been assigned. In this example, access controller 254 would advertise the route 10.1.1.3/32, thereby attracting packets that are destined for mobile device 255 at 10.1.1.3 from both router/NAT 256 and access controller 252. In this embodiment, the network separating access controller 252, access controller 254, and router/NAT 256 does not need to be an Ethernet router, as routing updates can travel across multiple subnets. In further embodiments, it may be desirable that router/NAT 256 aggregate routes from access controller 252 and access controller 254 before advertising them into the intranet 257 to avoid churn in the intranet routing tables.

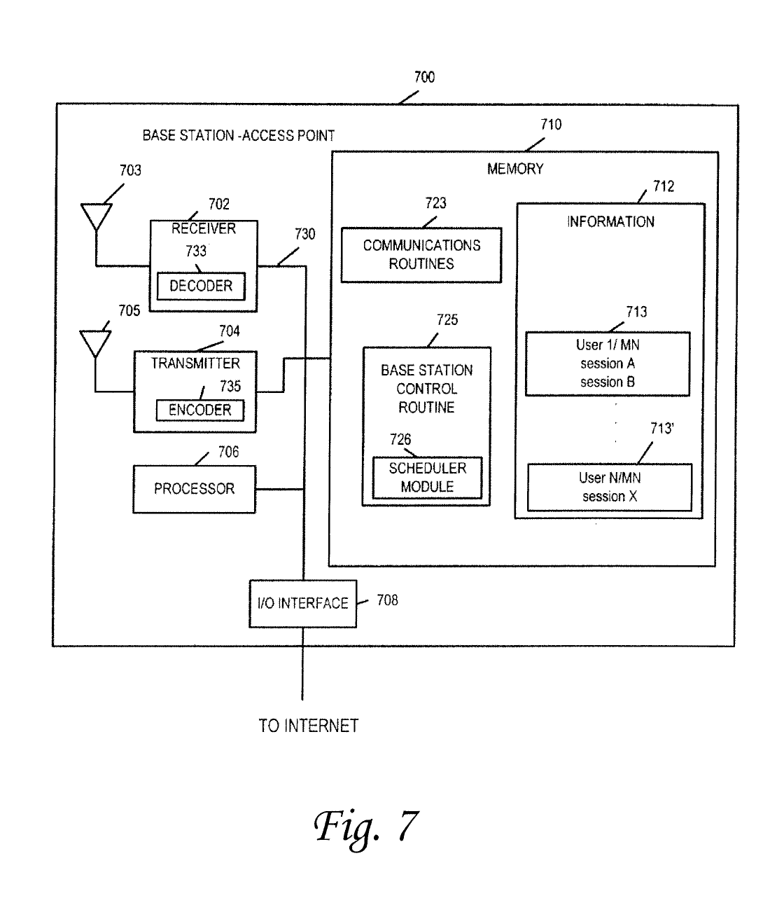

FIG. 7 illustrates an exemplary access point, e.g., a base station 700, implemented in accordance with the invention. The access point 700 includes antennas 703, 705 and receiver transmitter circuitry 702, 704. The receiver circuitry 702 includes a decoder 733 while the transmitter circuitry 704 includes an encoder 735. The receiver transmitter circuitry 702, 704 is coupled by a bus 730 to an I/O interface 708, processor (e.g., CPU) 706 and memory 710. The I/O interface 708 couples the access point 700 to the IP network and/or other network nodes. The memory 710 includes routines, which when executed by the processor 706, cause the access point 700 to operate in accordance with the invention. Memory includes communications routines 723 used for controlling the access point 700 to perform various communications operations and implement various communications protocols. The memory 710 also includes an access point/base station control routine 725 used to control the access point 700 to implement the steps of the method of the present invention described above in various sections. The access point control routine 725 includes a scheduling module 726 used to control transmission scheduling and/or communication resource allocation. Thus, module 726 may serve as a scheduler. Memory 710 also includes information used by communications routines 723, and control routine 725. The information 712 includes an entry for each active mobile node/wireless terminal user 713, 713′ which lists the active sessions being conducted by the user and includes information identifying the mobile station/wireless terminal (WT) being used by a user to conduct the sessions.

Servers and/or host devices may be implemented using circuitry which is the same as, or similar to, the circuitry of the exemplary access point 700 shown in FIG. 7 but with interfaces and/or control routines suited to, e.g., which implements the particular server/host device's requirements. The control routines and/or hardware in such servers and/or hosts cause the devices to implement the above described methods.

Although two separate antennas are illustrated for the transmit and receive channels in this and other example architectural drawings contained herein, one of ordinary skill in the art will understand that various antenna and antenna configurations and different numbers of antennas can be provided. For example, transmit and receive functions can occur using a common antenna or antenna structure, or separate antennas or antenna structures can be provided for transmit and receive functions as illustrated. In addition, antenna arrays or other groups of multiple antennas or antenna elements, including combinations of passive and active elements, can be used for the transmit and/or receive functions.

FIG. 8 illustrates an exemplary wireless terminal 800 implemented in accordance with the present invention. The exemplary wireless terminal 800 may be configured in accordance with any mobile device described herein. The wireless terminal 800 includes receiver and transmitter antennas 803, 805 which are coupled to receiver and transmitter circuitry 802, 804 respectively. The receiver circuitry 802 includes a decoder 833 while the transmitter circuitry 804 includes an encoder 835. The receiver transmitter circuits 802, 804 are coupled by a bus 809 to a memory 810. Processor 806, under control of one or more routines stored in memory 810 causes the wireless terminal 800 to operate in accordance with the methods of the present invention as described above. In order to control the operation of wireless terminal 800, memory includes communications routine 823, and mobile node control routine 825. The wireless terminal routine is responsible for insuring that the wireless terminal operates in accordance with the methods of the present invention and performs the steps described above in regard to wireless terminal operations. The memory 810 also includes user/device/session/resource information 812 which may be accessed and used to implement the methods of the present invention and/or data structures used to implement the invention.

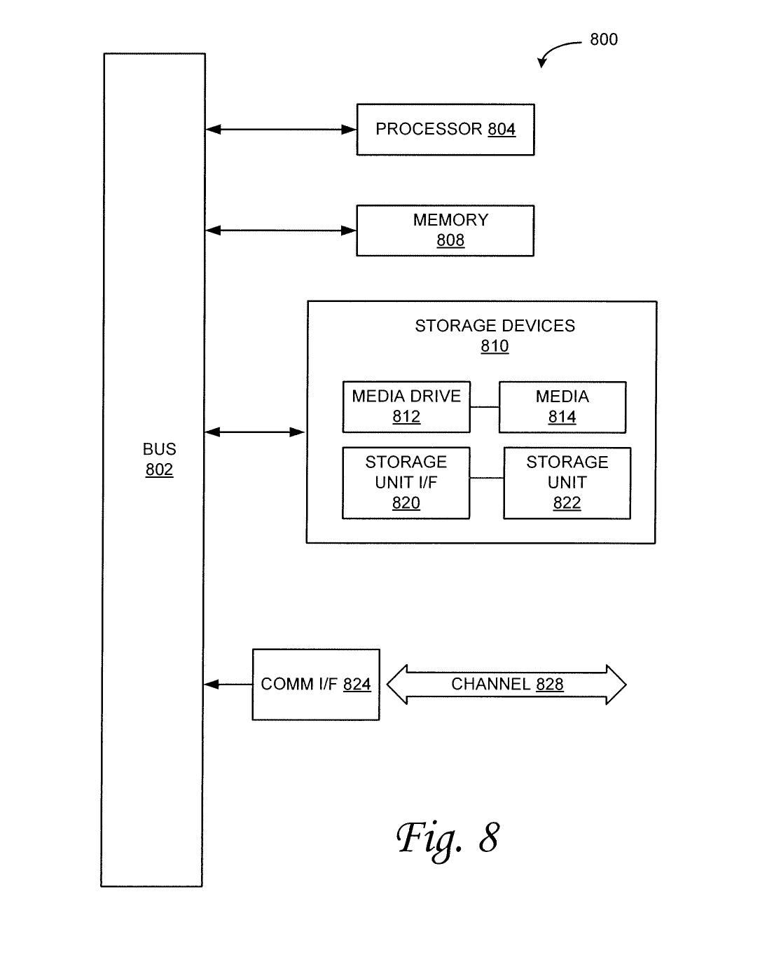

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 9. Various embodiments are described in terms of this example-computing module 800. After reading this description, it will become apparent to a person skilled in the relevant art how to implement the invention using other computing modules or architectures.

Referring now to FIG. 9, computing module 800 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally.

Computing module 800 might also include one or more memory modules, simply referred to herein as main memory 808. For example, preferably random access memory (RAM) or other dynamic memory, might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device coupled to bus 802 for storing static information and instructions for processor 804.

The computing module 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD or DVD drive (R or RW), or other removable or fixed media drive might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing module 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory module) and memory slot, a PCMCIA slot and card, and other fixed or removable storage units 822 and interfaces 820 that allow software and data to be transferred from the storage unit 822 to computing module 800.

Computing module 800 might also include a communications interface 824. Communications interface 824 might be used to allow software and data to be transferred between computing module 800 and external devices. Examples of communications interface 824 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 824 might typically be carried on signals, which can be electronic, electromagnetic (which includes optical) or other signals capable of being exchanged by a given communications interface 824. These signals might be provided to communications interface 824 via a channel 828. This channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 808, storage unit 820, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A communications system, comprising:
a local femtocell access point base station;
a local access point controller in communication with the local femtocell access point base station and an external network support node, wherein the external network support node is in communication with an external macrocell access point base station;
a local DHCP server;
wherein the external network support node is configured to assign an IP address using the local DHCP server to a first affiliated mobile device if the mobile device connects to the system using the external macrocell access point base station and if the device connects to the system using the local femtocell access point base station;
wherein the external network support node is configured to direct IP data traffic from the affiliated mobile device to the local access point controller if the affiliated mobile device is connected to the external macrocell access point base station; and
wherein the local access point controller is configured to enable an inbound handoff of the affiliated mobile device from the external macrocell access point base station to the local femtocell access point base station and is configured to enable an outbound handoff of the affiliated mobile device from the local femtocell access point base station to the external macrocell access point base station, wherein the IP address is maintained after the inbound handoff and after the outbound handoff.

2. The system of claim 1, wherein the local access point controller is configured to mediate communications between the affiliated mobile device and an enterprise network and between the affiliated mobile device and an external interne.

3. The system of claim 2, wherein the local access point controller is configured to receive IP traffic from the affiliated mobile device via a virtual private network connection to the external network support node when the affiliated mobile device is connected to the external macrocell access point base station.

4. The system of claim 3, wherein the local access point controller is configured to receive IP traffic from the affiliated mobile device via the local femtocell access point base station when the affiliated mobile device is connected to the local femtocell access point base station.

5. The system of claim 4, wherein the external network support node maintains a first routing table comprising the IP address and configured to enable the external network support node to direct IP traffic from the affiliated mobile device to the local access point controller when the locally affiliated mobile device is connected to the external macrocell access point base station; and wherein the local access point controller maintains a second routing table and updates the second routing table with the IP address during the handoff and the external network support node deletes the IP address from the first routing table during the handoff.

6. The system of claim 5, further comprising a second local access point controller in communication with the first local access point controller and in communication with a second femtocell access point base station, and wherein the first local access point controller mediates communications between the second local access point controller and the external network support node.

7. The system of claim 1, wherein the local femtocell access point base station and the local access point controller are modules within a common housing.

8. A method of network operation, comprising:
maintaining a routing table of locations of affiliated mobile devices;
receiving a data packet destined for an affiliated mobile device;
routing the data packet to the affiliated mobile device through an external cellular network support node if the affiliated mobile device is connected to the external cellular network; and
routing the data packet to the affiliated mobile device through a local femtocell if the affiliated mobile device is connected to the local femtocell network.

9. The method of claim 8, further comprising:
receiving a request to handoff the affiliated mobile device to the external cellular network; and
maintaining the IP address of the affiliated mobile device after the handoff.

10. The method of claim 9, further comprising:
receiving a request from the external cellular network support node for an IP address for the affiliated mobile device; and
providing an IP address from a local DHCP server to the external cellular network support node.

11. The method of claim 9, further comprising:
receiving a request to handoff the affiliated mobile device from the external network to the femtocell network; and
entering an IP address of the affiliated mobile device into the routing table to implement the handoff.

12. The method of claim 8, further comprising:
receiving a data packet from the affiliated mobile device, wherein the data packet is addressed to a second affiliated mobile device; and
locally routing the data packet to the second affiliated mobile device.

13. The method of claim 8, further comprising:
receiving a data packet from the affiliated mobile device, wherein the data packet is addressed to a local network service on an intranet; and
routing the data packet to the intranet.

14. Computer executable program code embodied on a computer readable medium configured to cause a femtocell access point controller to perform the steps of:
maintaining a routing table of locations of affiliated mobile devices;
receiving a data packet destined for an affiliated mobile device;
routing the data packet to the affiliated mobile device through an external cellular network support node if the affiliated mobile device is connected to the external cellular network; and
routing the data packet to the affiliated mobile device through a local femtocell if the affiliated mobile device is connected to the local femtocell network.

15. The computer executable program code of claim 14, further configured to cause the femtocell access point controller to perform the steps of:
receiving a request to handoff the affiliated mobile device to the external cellular network; and
maintaining the IP address of the affiliated mobile device after the handoff.

16. The computer executable program code of claim 15, further configured to cause the femtocell access point controller to perform the steps of:
receiving a request from the external cellular network support node for an IP address for the affiliated mobile device; and
providing an IP address from a local DHCP server to the external cellular network support node.

17. The computer executable program code of claim 15, further configured to cause the femtocell access point controller to perform the steps of:
receiving a request to handoff the affiliated mobile device from the external network to the femtocell network; and
entering an IP address of the affiliated mobile device into the routing table to implement the handoff.

18. The computer executable program code of claim 14, further configured to cause the femtocell access point controller to perform the steps of:
receiving a data packet from the affiliated mobile device, wherein the data packet is addressed to a second affiliated mobile device; and
locally routing the data packet to the second affiliated mobile device.

19. The computer executable program code of claim 14, further configured to cause the femtocell access point controller to perform the steps of:
receiving a data packet from the affiliated mobile device, wherein the data packet is addressed to a local network service on an intranet; and
routing the data packet to the intranet.

20. The computer executable program code of claim 14, wherein the femtocell access point controller and the local femtocell comprise modules contained within a common housing.
